(19) United States
(12) Patent Application Publication
(10) Pub. No.: US 2023/0028264 A1
(43) Pub. Date: Jan. 26, 2023

(54) Method of Mass Analysis - Controlling Viscosity of Solvent for OPP Operation

(71) Applicant: DH TECHNOLOGIES DEVELOPMENT PTE. LTD., Singapore (SG)

(72) Inventor: Yves Le Blanc, Newmarket (CA)

(21) Appl. No.: 17/758,306

(22) PCT Filed: Jan. 13, 2021
(86) PCT No.: PCT/IB2021/050229

§ 371 Date: Jul. 1, 2022

Related U.S. Application Data
(60) Provisional application No. 62/960,735, filed on Jan. 14, 2020.

(51) Int. Cl. B01L 3/02; B01L 3/00; G01N 35/10

(52) U.S. Cl. CPC B01L 3/0268; B01L 3/0279; B01L 3/50851; B01L 3/022; G01N 35/1002; B01L 2400/0406

(57) ABSTRACT

A droplet (415) is ejected from a surface (411) of a fluid sample containing an analyte using an ejector (420). A solvent is pumped into a solvent inlet (432) of an open port probe (OPP) (430) spaced apart from the surface using a pump (438). The solvent is pumped to send it from the solvent inlet (432) to a tip (431) of the OPP (430) through a solvent capillary (434) of the OPP (430), receive the droplet (415) at the tip (431) where the droplet is combined with the solvent to form an analyte-solvent dilution, and transport the dilution from the tip (431) to an output (435) of the OPP (430) through a sample capillary (436) of the OPP (430). The solvent is heated to a temperature above a threshold temperature using a heating element (437). The solvent is heated to reduce the viscosity of the solvent below a threshold viscosity and maintain the viscosity below the threshold viscosity as the dilution is transported from the tip (431) to the outlet (435).

### RELATED APPLICATIONS

This application claims the benefit of U.S. Provisional Patent Application Ser. No. 62/960,735, filed on Jan. 14, 2020, the content of which is incorporated by reference herein in its entirety.

### INTRODUCTION

The teachings herein relate to an open port probe (OPP) that is used in conjunction with an acoustic droplet ejection (ADE) device to deliver small amounts of a fluid sample from a microtiter plate well to a mass spectrometer or other analytical devices. More specifically, systems and methods are provided for controlling the temperature of solvents in an OPP to allow solvents with higher viscosities to be used, to accommodate higher liquid flows, and to reduce gas flow requirements.

### Low Viscosity Problem

An OPP device currently relies on a low viscosity solvent to ensure proper operation. A low viscosity solvent allows a sample to rapidly transit the tubing of the device and balances the Venturi effect generated by the nebulizing gas.

To meet this requirement, pure organic solvents such as methanol (MeOH) and acetonitrile (ACN) with some level of additives are typically recommended and used. Other solvents such as isopropanol and even water are not recommended. These solvents significantly lower the flow rates that can be used and, therefore, reduce the sample throughput.

Unfortunately, however, using higher viscosity solvents can provide some advantages for mass spectrometry and other analytical device techniques. For example, the ability to use a higher viscosity liquid such as water can further improve operational stability. It is easier to operate ion sources in the presence of some level of water. Also, water offers solubility for a wider range of analytes and is better at preventing precipitation than other solvents. Other additives such as IPA (isopropanol) and DMSO (dimethylsufoxide) have also shown benefits with respect to ion formation and spray stability, but their presence also increase the viscosity of the liquid.

In addition, being able to accommodate higher viscosity solvents means that the Venturi effect generated by the nebulizing gas can more easily be balanced. For example, liquid flow of lower viscosity solvents can be increased further for a fixed nebulizing gas flow. In other words, accommodating higher viscosity solvents also means potentially providing higher liquid flows for lower viscosity solvents.

Similarly, being able to accommodate higher viscosity solvents means that nebulizing gas flow can be reduced for a fixed or desirable liquid flow rate. In other words, accommodating higher viscosity solvents also means potentially allowing for reduced nebulizing gas flow when lower viscosity solvents are used.

As a result, additional OPP systems and methods are needed to allow solvents with higher viscosities to be used, to accommodate higher liquid flows, and to reduce gas flow requirements.

### Open Port Probe Background

Accurate determination of the presence, identity, concentration, and/or quantity of an analyte in a sample is critically important in many fields. Many techniques used in such analyses involve ionization of species in a fluid sample prior to introduction into the analytical equipment employed. The choice of ionization method will depend on the nature of the sample and the analytical technique used, and many ionization methods are available. Mass spectrometry is a well-established analytical technique in which sample molecules are ionized and the resulting ions then sorted by mass-to-charge ratio.

The ability to couple mass spectrometric analysis, particularly electrospray mass spectrometric analysis, to separation techniques, such as liquid chromatography (LC), including high-performance liquid chromatography (HPLC), capillary electrophoresis, or capillary electrochromatography, has meant that complex mixtures can be separated and characterized in a single process. Improvements in HPLC system design, such as reductions in dead volumes and an increase in pumping pressure, have enabled the benefits of smaller columns containing smaller particles, improved separation, and faster run time to be realized. Despite these improvements, the time required for sample separation is still around one minute. Even if real separation is not required, the mechanics of loading samples into the mass spectrometer still limit sample loading time to about ten seconds per sample using conventional autosamplers with some level of cleanup between injections.

There has been some success in improving throughput performance. Simplifying sample processing by using solid-phase extraction, rather than traditional chromatography, to remove salts can reduce pre-injection times to under ten seconds per sample from the minutes per sample required for HPLC. However, the increase in sampling speed comes at the cost of sensitivity. Furthermore, the time saved by the increase in sampling speed is offset by the need for cleanup between samples.

Another limitation of current mass spectrometer loading processes is the problem of carryover between samples, which necessitates a cleaning step after each sample is loaded to avoid contamination of a subsequent sample with a residual amount of analyte in the prior sample. This requires time and adds a step to the process, complicating rather than streamlining the analysis with conventional autosampler systems.

Additional limitations of current mass spectrometers when used to process complex samples, such as biological fluids, are unwanted “matrix effects,” phenomena that result from the presence of matrix components (e.g., natural matrix components such as cellular matrix components, or contaminants inherent in some materials such as plastics) and adversely affect detection capability, precision, and/or accuracy for the analyte of interest.

Several of the aforementioned limitations have been addressed by using acoustic droplet ejection (ADE) to deliver small amounts of a fluid sample from individual microtiter plate wells to a mass spectrometer or other analytical devices. See Sinclair et al. (2016) Journal of Laboratory Automation 21(1):19-26 and U.S. Pat. No. 7,405,395 to Ellson et al. (Labcyte Inc., San Jose, Calif.), both of which are incorporated by reference in their entireties. Unfortunately, as noted by Sinclair et al., potential matrix effects can still be problematic for ADE. Additionally, for applications in which a consistent droplet size is necessary or desirable, the acoustic mist approach is less than ideal, insofar as droplets with different sizes are generated by a single acoustic burst.

In order to overcome the limitations found in using ADE to deliver small amounts of a fluid sample from individual microtiter plate wells to a mass spectrometer or other analytical devices, a system was developed combining ADE with an open port probe (OPP) sampling interface for high-throughput mass spectrometry. This system is described in U.S. patent application Ser. No. 16/198,667 (hereinafter the “'667 Application”), which is incorporated herein in its entirety.

FIG. 1A is an exemplary system combining ADE with an OPP sampling interface, as described in the '667 Application. In FIG. 1A, the ADE device is shown generally at 11, ejecting droplet 49 toward the continuous flow OPP indicated generally at 51 and into the sampling tip 53 thereof.

ADE device 11 includes at least one reservoir, with a first reservoir shown at 13 and an optional second reservoir 31. In some embodiments, a further plurality of reservoirs may be provided. Each reservoir is configured to house a fluid sample having a fluid surface, e.g., a first fluid sample 14 and a second fluid sample 16 having fluid surfaces respectively indicated at 17 and 19. The fluid samples 14 and 16 may be the same or different, but are generally different, insofar as they will ordinarily contain two different analytes intended to be transported to and detected in an analytical instrument (not shown). The analyte may be a biomolecule or a macromolecule other than a biomolecule, or it may be a small organic molecule, an inorganic compound, an ionized atom, or any moiety of any size, shape, or molecular structure, as explained earlier in this section. In addition, the analyte may be dissolved, suspended or dispersed in the liquid component of the fluid sample.

When more than one reservoir is used, as illustrated in FIG. 1A, the reservoirs are preferably both substantially identical and substantially acoustically indistinguishable, although identical construction is not a requirement. As explained earlier in this section, the reservoirs may be separate removable components in a tray, rack, or other such structure, but they may also be fixed within a plate, e.g., a well plate, or another substrate. Each reservoir is preferably substantially axially symmetric, as shown, having vertical walls 21 and 23 extending upward from circular reservoir bases 25 and 27, and terminating at openings 29 and 31, respectively, although other reservoir shapes and reservoir base shapes may be used. The material and thickness of each reservoir base should be such that acoustic radiation may be transmitted therethrough and into the fluid sample contained within each reservoir.

ADE device 11 comprises acoustic ejector 33, which includes acoustic radiation generator 35 and focusing means 37 for focusing the acoustic radiation generated at a focal point 47 within the fluid sample, near the fluid surface. As shown in FIG. 1A, the focusing means 37 may comprise a single solid piece having a concave surface 39 for focusing the acoustic radiation, but the focusing means may be constructed in other ways as discussed below. The acoustic ejector 33 is thus adapted to generate and focus acoustic radiation so as to eject a droplet of fluid from each of the fluid surfaces 17 and 19 when acoustically coupled to reservoirs 13 and 15, and thus to fluids 14 and 16, respectively. The acoustic radiation generator 35 and the focusing means 37 may function as a single unit controlled by a single controller, or they may be independently controlled, depending on the desired performance of the device.

Optimally, acoustic coupling is achieved between the ejector and each of the reservoirs through indirect contact, as illustrated in FIG. 1A. In the figure, an acoustic coupling medium 41 is placed between the ejector 33 and the base 25 of reservoir 13, with the ejector and reservoir located at a predetermined distance from each other. The acoustic coupling medium may be an acoustic coupling fluid, preferably an acoustically homogeneous material in conformal contact with both the acoustic focusing means 37 and the underside of the reservoir. In addition, it is important to ensure that the fluid medium is substantially free of material having different acoustic properties than the fluid medium itself. As shown, the first reservoir 13 is acoustically coupled to the acoustic focusing means 37 such that an acoustic wave generated by the acoustic radiation generator is directed by the focusing means 37 into the acoustic coupling medium 41, which then transmits the acoustic radiation into the reservoir 13. The system may contain a single acoustic ejector, as illustrated in FIG. 1A, or, as noted previously, it may contain multiple ejectors.

In operation, reservoir 13 and optional reservoir 15 of the device are filled with first and second fluid samples 14 and 16, respectively, as shown in FIG. 1A. The acoustic ejector 33 is positioned just below reservoir 13, with acoustic coupling between the ejector and the reservoir provided by means of acoustic coupling medium 41. Initially, the acoustic ejector is positioned directly below sampling tip 53 of OPP 51, such that the sampling tip faces the surface 17 of the fluid sample 14 in the reservoir 13. Once the ejector 33 and reservoir 13 are in proper alignment below sampling tip 53, the acoustic radiation generator 35 is activated to produce acoustic radiation that is directed by the focusing means 37 to a focal point 47 near the fluid surface 17 of the first reservoir. As a result, droplet 49 is ejected from the fluid surface 17 toward and into the liquid boundary 50 at the sampling tip 53 of the OPP 51, where it combines with solvent in the flow probe 53.

The profile of the liquid boundary 50 at the sampling tip 53 may vary from extending beyond the sampling tip 53 to projecting inward into the OPP 51. In a multiple-reservoir system, the reservoir unit (not shown), e.g., a multi-well plate or tube rack, can then be repositioned relative to the acoustic ejector such that another reservoir is brought into alignment with the ejector and a droplet of the next fluid sample can be ejected. The solvent in the flow probe cycles through the probe continuously, minimizing or even eliminating “carryover” between droplet ejection events.

Fluid samples 14 and 16 are samples of any fluid for which transfer to an analytical instrument is desired. Accordingly, the fluid sample may contain a solid that is minimally, partially or fully solvated, dispersed, or suspended in a liquid, which may be an aqueous liquid or a nonaqueous liquid. The structure of OPP 51 is also shown in FIG. 1A. Any number of commercially available continuous flow OPPs can be used as is or in modified form, all of which, as is well known in the art, operate according to substantially the same principles. As can be seen in FIG. 1A, the sampling tip 53 of OPP 51 is spaced apart from the fluid surface 17 in the reservoir 13, with a gap 55 therebetween. The gap 55 may be an air gap, or a gap of an inert gas, or it may comprise some other gaseous material; there is no liquid bridge connecting the sampling tip 53 to the fluid 14 in the reservoir 13.

The OPP 51 includes a solvent inlet 57 for receiving solvent from a solvent source and a solvent transport capillary 59 for transporting the solvent flow from the solvent inlet 57 to the sampling tip 53, where the ejected droplet 49 of analyte-containing fluid sample 14 combines with the solvent to form an analyte-solvent dilution. A solvent pump (not shown) is operably connected to and in fluid communication with solvent inlet 57 in order to control the rate of solvent flow into the solvent transport capillary and thus the rate of solvent flow within the solvent transport capillary 59 as well.

Fluid flow within the probe 53 carries the analyte-solvent dilution through a sample transport capillary 61 provided by inner capillary tube 73 toward sample outlet 63 for subsequent transfer to an analytical instrument. A sampling pump (not shown) can be provided that is operably connected to and in fluid communication with the sample transport capillary 61, to control the output rate from outlet 63. Suitable solvent pumps and sampling pumps will be known to those of ordinary skill in the art, and include displacement pumps, velocity pumps, buoyancy pumps, syringe pumps, and the like; other examples are given in U.S. Pat. No. 9,395,278 to Van Berkel et al., the disclosure of which is incorporated by reference herein.

In a preferred embodiment, a positive displacement pump is used as the solvent pump, e.g., a peristaltic pump, and, instead of a sampling pump, an aspirating nebulization system is used so that the analyte-solvent dilution is drawn out of the sample outlet 63 by the Venturi effect caused by the flow of the nebulizing gas introduced from a nebulizing gas source 65 via gas inlet 67 (shown in simplified form in FIG. 1A, insofar as the features of aspirating nebulizers are well known in the art) as it flows over the outside of the sample outlet 63. The analyte-solvent dilution flow is then drawn upward through the sample transport capillary 61 by the pressure drop generated as the nebulizing gas passes over the sample outlet 63 and combines with the fluid exiting the sample transport capillary 61. A gas pressure regulator is used to control the rate of gas flow into the system via gas inlet 67.

In a preferred manner, the nebulizing gas flows over the outside of the sample transport capillary 61 at or near the sample outlet 63 in a sheath flow type manner which draws the analyte-solvent dilution through the sample transport capillary 61 as it flows across the sample outlet 63 that causes aspiration at the sample outlet upon mixing with the nebulizer gas.

The solvent transport capillary 59 and sample transport capillary 61 are provided by outer capillary tube 71 and inner capillary tube 73 substantially co-axially disposed therein, where the inner capillary tube 73 defines the sample transport capillary, and the annular space between the inner capillary tube 73 and outer capillary tube 71 defines the solvent transport capillary 59. The dimensions of the inner capillary tube 73 can be from 1 micron to 1 mm, e.g., 200 microns. Typical dimensions of the outer diameter of the inner capillary tube 73 can be from 100 microns to 3 or 4 centimeters, e.g., 360 microns. Typical dimensions of the inner diameter of the outer capillary tube 71 can be from 100 microns to 3 or 4 centimeters, e.g., 450 microns. Typical dimensions of an outer diameter of the outer capillary tube 71 can be from 150 microns to 3 or 4 centimeters, e.g., 950 microns. The cross-sectional areas of the inner capillary tube 73 and/or the outer capillary tube 71 can be circular, elliptical, superelliptical (i.e., shaped like a superellipse), or even polygonal. While the illustrated system in FIG. 1A indicates the direction of solvent flow as downward from the solvent inlet 57 toward sampling tip 53 in the solvent transport capillary 59 and the direction of the analyte-solvent dilution flow as upward from the sampling tip 53 upward through the sample transport capillary 61 toward outlet 63, the directions can be reversed, and the OPP 51 is not necessarily positioned to be exactly vertical. Various modifications to the structure shown in FIG. 1A will be apparent to those of ordinary skill in the art, or may be deduced by those of ordinary skill in the art during use of the system.

The system can also include an adjuster 75 coupled to the outer capillary tube 71 and the inner capillary tube 73. The adjuster 75 can be adapted for moving the outer capillary tube tip 77 and the inner capillary tube tip 79 longitudinally relative to one another. The adjuster 75 can be any device capable of moving the outer capillary tube 71 relative to the inner capillary tube 73. Exemplary adjusters 75 can be motors including, but not limited to, electric motors (e.g., AC motors, DC motors, electrostatic motors, servo motors, etc.), hydraulic motors, pneumatic motors, translational stages, and combinations thereof. As used herein, “longitudinally” refers to an axis that runs the length of the OPP 51, and the inner and outer capillary tubes 73, 71 can be arranged coaxially around a longitudinal axis of the OPP 51, as shown in FIG. 1.

Optionally, prior to use, the adjuster 75 is used to draw the inner capillary tube 73 longitudinally inward so that the outer capillary tube 71 protrudes beyond the end of the inner capillary tube 73, so as to facilitate optimal fluid communication between the solvent flow in the solvent transport capillary 59 and the sample transported as an analyte-solvent dilution flow 61 in the sample transport capillary 61. Additionally, as illustrated in FIG. 1A, the OPP 51 is generally affixed within an approximately cylindrical holder 81, for stability and ease of handling.

FIG. 1B is an exemplary system 110 for ionizing and mass analyzing analytes received within an open end of a sampling OPP, as described in the '667 Application. System 110 includes acoustic droplet injection device 11 configured to inject a droplet 49 from a reservoir into the open end of sampling OPP 51. As shown in FIG. 1B, the exemplary system 110 generally includes a sampling OPP 51 in fluid communication with a nebulizer-assisted ion source 160 for discharging a liquid containing one or more sample analytes (e.g., via electrospray electrode 164) into an ionization chamber 112, and a mass analyzer 170 in fluid communication with the ionization chamber 112 for downstream processing and/or detection of ions generated by the ion source 160. A fluid handling system 140 (e.g., including one or more pumps 143 and one or more conduits) provides for the flow of liquid from a solvent reservoir 150 to the sampling OPP 51 and from the sampling OPP 51 to the ion source 160. For example, as shown in FIG. 1B, the solvent reservoir 150 (e.g., containing a liquid, desorption solvent) can be fluidly coupled to the sampling OPP 51 via a supply conduit through which the liquid can be delivered at a selected volumetric rate by the pump 143 (e.g., a reciprocating pump, a positive displacement pump such as a rotary, gear, plunger, piston, peristaltic, diaphragm pump, or other pump such as a gravity, impulse, pneumatic, electrokinetic, and centrifugal pump), all by way of non-limiting example. As discussed in detail below, the flow of liquid into and out of the sampling OPP 51 occurs within a sample space accessible at the open end such that one or more droplets 49 can be introduced into the liquid boundary 50 at the sample tip and subsequently delivered to the ion source 160.

As shown, the system 110 includes an acoustic droplet injection device 11 that is configured to generate acoustic energy that is applied to a liquid contained within a reservoir (as depicted in FIG. 1A) that causes one or more droplets 49 to be ejected from the reservoir into the open end of the sampling OPP 51. A controller 180 can be operatively coupled to the acoustic droplet injection device 11 and can be configured to operate any aspect of the acoustic droplet injection device 11 (e.g., focusing means, acoustic radiation generator, automation means for positioning one or more reservoirs into alignment with the acoustic radiation generator, etc.) so as to inject droplets into the sampling OPP 51 or otherwise discussed herein substantially continuously or for selected portions of an experimental protocol by way of non-limiting example. Controller 180 can be, but is not limited to, a microcontroller, a computer, a microprocessor, the computer system of FIG. 1, or any device capable of sending and receiving control signals and data.

As shown in FIG. 1B, the exemplary ion source 160 can include a source 65 of pressurized gas (e.g. nitrogen, air, or a noble gas) that supplies a high velocity nebulizing gas flow which surrounds the outlet end of the electrospray electrode 164 and interacts with the fluid discharged therefrom to enhance the formation of the sample plume and the ion release within the plume for sampling by 114b and 116b, e.g., via the interaction of the high speed nebulizing flow and jet of liquid sample (e.g., analyte-solvent dilution). The nebulizer gas can be supplied at a variety of flow rates, for example, in a range from about 0.1 L/min to about 20 L/min, which can also be controlled under the influence of controller 180 (e.g., via opening and/or closing valve 163).

It will be appreciated that the flow rate of the nebulizer gas can be adjusted (e.g., under the influence of controller 180) such that the flow rate of liquid within the sampling OPP 51 can be adjusted based, for example, on suction/aspiration force generated by the interaction of the nebulizer gas and the analyte-solvent dilution as it is being discharged from the electrospray electrode 164 (e.g., due to the Venturi effect).

As shown in FIG. 1B, the ionization chamber 112 can be maintained at atmospheric pressure, though in some embodiments, the ionization chamber 112 can be evacuated to a pressure lower than atmospheric pressure. The ionization chamber 112, within which the analyte can be ionized as the analyte-solvent dilution is discharged from the electrospray electrode 164, is separated from a gas curtain chamber 114 by a plate 114a having a curtain plate aperture 114b. As shown, a vacuum chamber 116, which houses the mass analyzer 170, is separated from the curtain chamber 114 by a plate 116a having a vacuum chamber sampling orifice 116b. The curtain chamber 114 and vacuum chamber 116 can be maintained at a selected pressure(s) (e.g., the same or different sub-atmospheric pressures, a pressure lower than the ionization chamber) by evacuation through one or more vacuum pump ports 118.

It will also be appreciated by a person skilled in the art and in light of the teachings herein that the mass analyzer 170 can have a variety of configurations. Generally, the mass analyzer 170 is configured to process (e.g., filter, sort, dissociate, detect, etc.) sample ions generated by the ion source 160. By way of non-limiting example, the mass analyzer 170 can be a triple quadrupole mass spectrometer, or any other mass analyzer known in the art and modified in accordance with the teachings herein. Other non-limiting, exemplary mass spectrometer systems that can be modified in accordance various aspects of the systems, devices, and methods disclosed herein can be found, for example, in an article entitled “Product ion scanning using a Q-q-Q linear ion trap (Q TRAP) mass spectrometer,” authored by James W. Hager and J. C. Yves Le Blanc and published in Rapid Communications in Mass Spectrometry (2003; 17: 1056-1064), and U.S. Pat. No. 7,923,681, entitled “Collision Cell for Mass Spectrometer,” which are hereby incorporated by reference in their entireties.

Other configurations, including but not limited to those described herein and others known to those skilled in the art, can also be utilized in conjunction with the systems, devices, and methods disclosed herein. For instance, other suitable mass spectrometers include single quadrupole, triple quadrupole, ToF, trap, and hybrid analyzers. It will further be appreciated that any number of additional elements can be included in the system 110 including, for example, an ion mobility spectrometer (e.g., a differential mobility spectrometer) that is disposed between the ionization chamber 112 and the mass analyzer 170 and is configured to separate ions based on their mobility through a drift gas in high- and low-fields rather than their mass-to-charge ratio). Additionally, it will be appreciated that the mass analyzer 170 can comprise a detector that can detect the ions which pass through the analyzer 170 and can, for example, supply a signal indicative of the number of ions per second that are detected.

### SUMMARY

A system, method, and computer program product are disclosed for transporting an analyte in a fluid sample to an analytical instrument and controlling the viscosity of the fluid sample. The system includes a reservoir, an ejector, and an OPP.

The reservoir houses a fluid sample containing an analyte. The fluid sample has a fluid surface. The ejector ejects a droplet of the fluid sample from the fluid surface. The OPP is spaced apart from the fluid surface.

The OPP includes a sampling tip for receiving the ejected droplet of the fluid sample. The OPP includes a solvent inlet for receiving a solvent from s solvent source or reservoir. The OPP includes a solvent transport capillary for transporting the solvent from the solvent inlet to the sampling tip, where the ejected droplet combines with the solvent to form an analyte-solvent dilution. The OPP 430 includes a sample outlet through which the analyte-solvent dilution is directed away from the OPP 430 to an analytical instrument. The OPP includes a sample transport capillary for transporting the analyte-solvent dilution from the sampling tip to the sample outlet. The sample transport capillary and the solvent transport capillary are in fluid communication at the sampling tip. Finally, the OPP includes a heating element that heats the solvent to a temperature above a threshold temperature in order to reduce a viscosity of the solvent below a threshold viscosity. This maintains the viscosity of the solvent below a threshold viscosity as the analyte-solvent dilution is transported from the sampling tip to the sample outlet.

These and other features of the applicant's teachings are set forth herein.

### BRIEF DESCRIPTION OF THE DRAWINGS

The skilled artisan will understand that the drawings, described below, are for illustration purposes only. The drawings are not intended to limit the scope of the present teachings in any way.

FIG. 1A is an exemplary system combining an acoustic droplet ejection (ADE) with an open port probe (OPP) sampling interface, as described in the '667 Application.

FIG. 1B is an exemplary system for ionizing and mass analyzing analytes received within an open end of a sampling OPP, as described in the '667 Application.

FIG. 2 is a block diagram that illustrates a computer system, upon which embodiments of the present teachings may be implemented.

FIG. 3A is an exemplary plot of the viscosities of methanol (MeOH), acetonitrile (ACN), and water (H₂O) plotted versus temperature, in accordance with various embodiments.

FIG. 3B is an exemplary plot of the viscosities of methanol (MeOH) and isopropanol (IPA) plotted versus temperature, in accordance with various embodiments.

FIG. 4 is a schematic diagram of a system for transporting an analyte in a fluid sample to an analytical instrument and controlling the viscosity of the fluid sample, in accordance with various embodiments.

FIG. 5 is a flowchart showing a method for transporting an analyte in a fluid sample to an analytical instrument and controlling the viscosity of the fluid sample, in accordance with various embodiments.

FIG. 6 is a schematic diagram of a system that includes one or more distinct software modules that performs a method for transporting an analyte in a fluid sample to an analytical instrument and controlling the viscosity of the fluid sample, in accordance with various embodiments.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the phraseology and terminology used herein is for the purpose of description and should not be regarded as limiting.

### DESCRIPTION OF VARIOUS EMBODIMENTS

### Computer-Implemented System

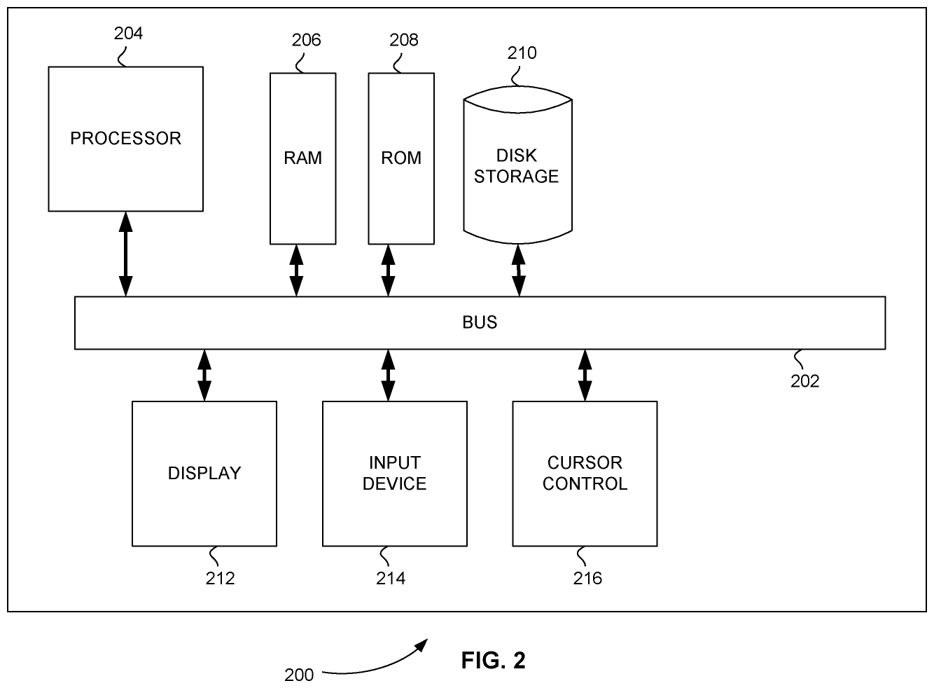

FIG. 2 is a block diagram that illustrates a computer system 200, upon which embodiments of the present teachings may be implemented. Computer system 200 includes a bus 202 or other communication mechanism for communicating information, and a processor 204 coupled with bus 202 for processing information. Computer system 200 also includes a memory 206, which can be a random-access memory (RAM) or other dynamic storage device, coupled to bus 202 for storing instructions to be executed by processor 204. Memory 206 also may be used for storing temporary variables or other intermediate information during execution of instructions to be executed by processor 204. Computer system 200 further includes a read only memory (ROM) 208 or other static storage device coupled to bus 202 for storing static information and instructions for processor 204. A storage device 210, such as a magnetic disk or optical disk, is provided and coupled to bus 202 for storing information and instructions.

Computer system 200 may be coupled via bus 202 to a display 212, such as a cathode ray tube (CRT) or liquid crystal display (LCD), for displaying information to a computer user. An input device 214, including alphanumeric and other keys, is coupled to bus 202 for communicating information and command selections to processor 204. Another type of user input device is cursor control 216, such as a mouse, a trackball or cursor direction keys for communicating direction information and command selections to processor 204 and for controlling cursor movement on display 212. This input device typically has two degrees of freedom in two axes, a first axis (i.e., x) and a second axis (i.e., y), that allows the device to specify positions in a plane.

A computer system 200 can perform the present teachings. Consistent with certain implementations of the present teachings, results are provided by computer system 200 in response to processor 204 executing one or more sequences of one or more instructions contained in memory 206. Such instructions may be read into memory 206 from another computer-readable medium, such as storage device 210. Execution of the sequences of instructions contained in memory 206 causes processor 204 to perform the process described herein. Alternatively, hard-wired circuitry may be used in place of or in combination with software instructions to implement the present teachings. Thus, implementations of the present teachings are not limited to any specific combination of hardware circuitry and software.

In various embodiments, computer system 200 can be connected to one or more other computer systems, like computer system 200, across a network to form a networked system. The network can include a private network or a public network such as the Internet. In the networked system, one or more computer systems can store and serve the data to other computer systems. The one or more computer systems that store and serve the data can be referred to as servers or the cloud, in a cloud computing scenario. The one or more computer systems can include one or more web servers, for example. The other computer systems that send and receive data to and from the servers or the cloud can be referred to as client or cloud devices, for example.

The term “computer-readable medium” as used herein refers to any media that participates in providing instructions to processor 204 for execution. Such a medium may take many forms, including but not limited to, non-volatile media, volatile media, and transmission media. Non-volatile media includes, for example, optical or magnetic disks, such as storage device 210. Volatile media includes dynamic memory, such as memory 206. Transmission media includes coaxial cables, copper wire, and fiber optics, including the wires that comprise bus 202.

Common forms of computer-readable media or computer program products include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 204 for execution. For example, the instructions may initially be carried on the magnetic disk of a remote computer. The remote computer can load the instructions into its dynamic memory and send the instructions over a telephone line using a modem. A modem local to computer system 200 can receive the data on the telephone line and use an infra-red transmitter to convert the data to an infra-red signal. An infra-red detector coupled to bus 202 can receive the data carried in the infra-red signal and place the data on bus 202. Bus 202 carries the data to memory 206, from which processor 204 retrieves and executes the instructions. The instructions received by memory 206 may optionally be stored on storage device 210 either before or after execution by processor 204.

In accordance with various embodiments, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

The following descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software, but the present teachings may be implemented as a combination of hardware and software or in hardware alone. The present teachings may be implemented with both object-oriented and non-object-oriented programming systems.

### Controlling the Temperature of Solvents in an OPP

As described above, an OPP device currently relies on a low viscosity solvent to ensure proper operation. A low viscosity solvent allows a sample to rapidly transit the tubing of the device and balances the Venturi effect generated by the nebulizing gas.

Unfortunately, however, using higher viscosity solvents can provide some advantages for mass spectrometry and other analytical device techniques. In addition, being able to accommodate higher viscosity solvents means that the Venturi effect generated by the nebulizing gas can more easily be balanced. For example, liquid flow of lower viscosity solvents can be increased further for a fixed nebulizing gas flow. Similarly, being able to accommodate higher viscosity solvents means that nebulizing gas flow can be reduced for a fixed or desirable liquid flow rate.

As a result, additional OPP systems and methods are needed to allow solvents with higher viscosities to be used, to accommodate higher liquid flows, and to reduce gas flow requirements.

In various embodiments, the liquid viscosity of a solvent in an OPP device is altered by controlling the temperature of the transfer line and/or the liquid injection port of the OPP. By adjusting the temperature in the range of 50-60° C., for example, a number of benefits are achieved. The first benefit is allowing solvents with higher viscosities to be used.

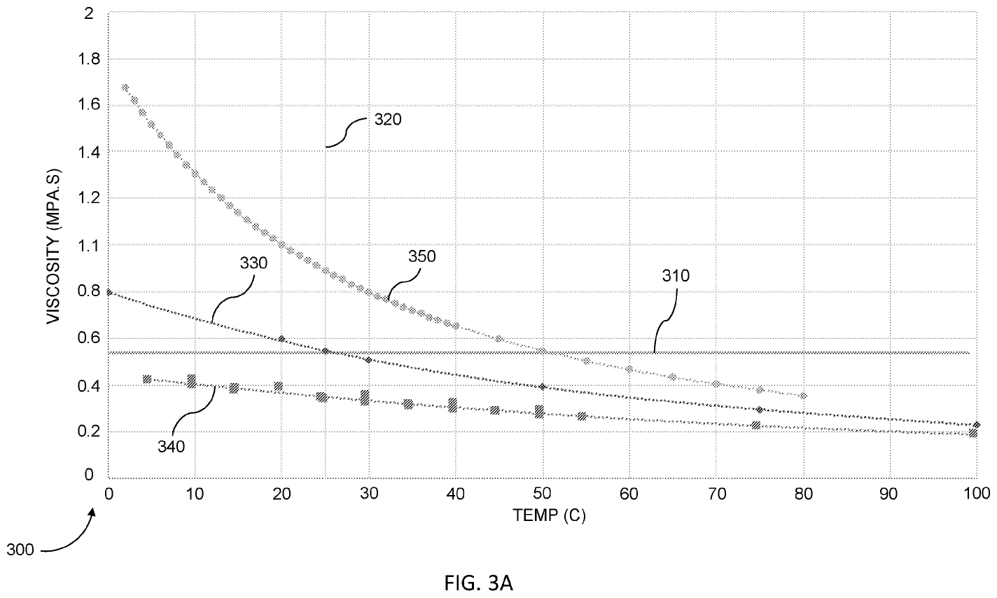

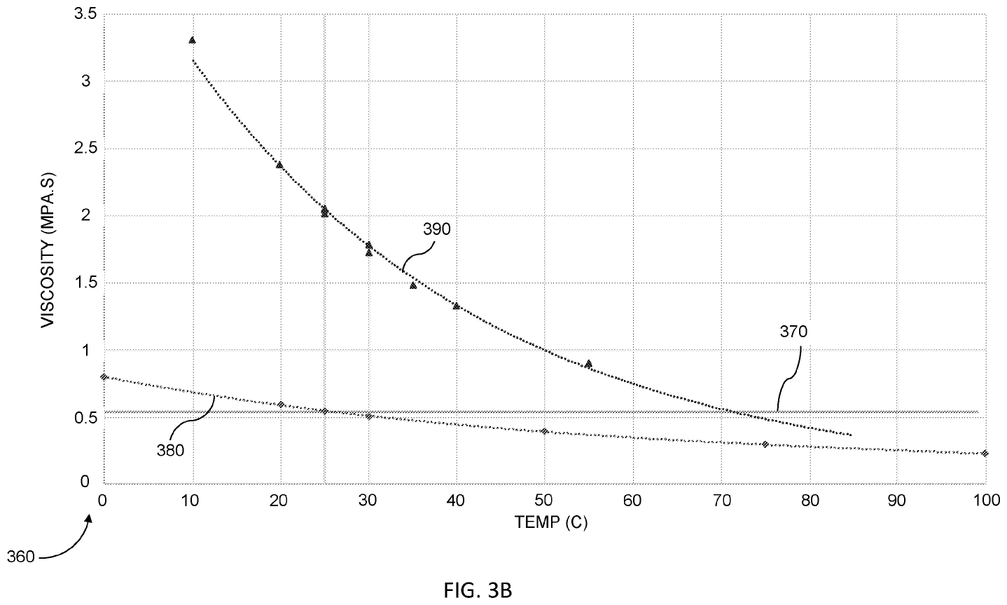

FIG. 3A is an exemplary plot 300 of the viscosities of methanol (MeOH), acetonitrile (ACN), and water (H₂O) plotted versus temperature, in accordance with various embodiments. In plot 300, line 310 depicts a viscosity threshold for solvents in an OPP device. Viscosities below line 310 are considered to be low enough to ensure proper operation of the OPP device. Similarly, plot 300 depicts line 320, which a temperature threshold. Temperatures above line 320 are above room temperature, for example.

Plot 300 shows that the viscosities of methanol 330 and the viscosities of acetonitrile 340 are below viscosity threshold line 310 for temperatures above temperature threshold line 320. In other words, and as described above, at room temperature or above, the viscosities of methanol 330 and the viscosities of acetonitrile 340 are low enough to ensure proper operation of the OPP device.

Plot 300 also shows that the viscosities of water 350 are below viscosity threshold line 310 for at least some temperatures above temperature threshold line 320. In other words, and as also described above, at room temperature and at least some temperatures above room temperature, the viscosities of water 350 are too high to ensure proper operation of the OPP device.

Adjusting the temperature of water in the range of 50-60° C., however, places the viscosities of water 350 low enough to ensure proper operation of the OPP device. In other words, the viscosity of water is reduced by increasing its temperature. As a result, plot 300 shows that increasing the temperature of the solvent in an OPP device can allow a higher viscosity liquid such as water at a high percentage (50%) to be used as the solvent. Again, using a higher viscosity liquid like water as a solvent can improve operational stability and offer solubility for a wider range of analytes.

Another benefit of adjusting the temperature of the solvent in an OPP device to a range of 50-60° C. is the ability to accommodate higher liquid flows. As shown in plot 300, adjusting the temperature of methanol or acetonitrile in the range of 50-60° C. further lowers the viscosities of methanol 330 and the viscosities of acetonitrile 340 below viscosity threshold line 310. This means that the flow rates of methanol or acetonitrile can be increased even when the nebulizer gas flow stays constant.

FIG. 3B is an exemplary plot 360 of the viscosities of methanol (MeOH) and isopropanol (IPA) plotted versus temperature, in accordance with various embodiments. In plot 360, line 370 depicts a viscosity threshold for solvents in an OPP device. Viscosities below line 310 are considered to be low enough to ensure proper operation of the OPP device. Plot 360 also shows that the viscosities of IPA 390 are below viscosity threshold line 370 for at least some temperatures above 70° C. In other words, at least some temperatures above room temperature will ensure proper operation of the OPP device when the viscosities of IPA 370 is significantly reduced (below 0.5). Similar plots could be obtained for mixtures of solvent, say water-IPA, where the starting viscosity would be elevated at room temperature, but reduced significantly when the temperature is raised between 50-70 C (data not shown).

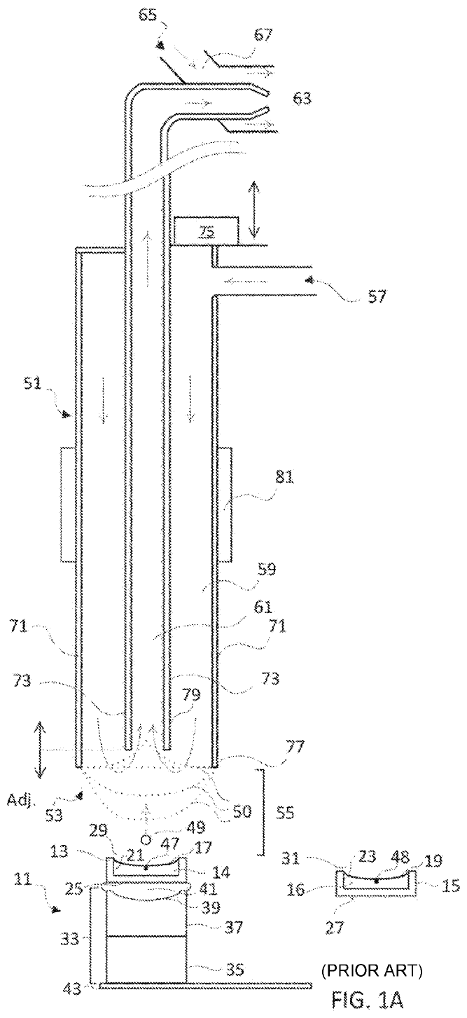

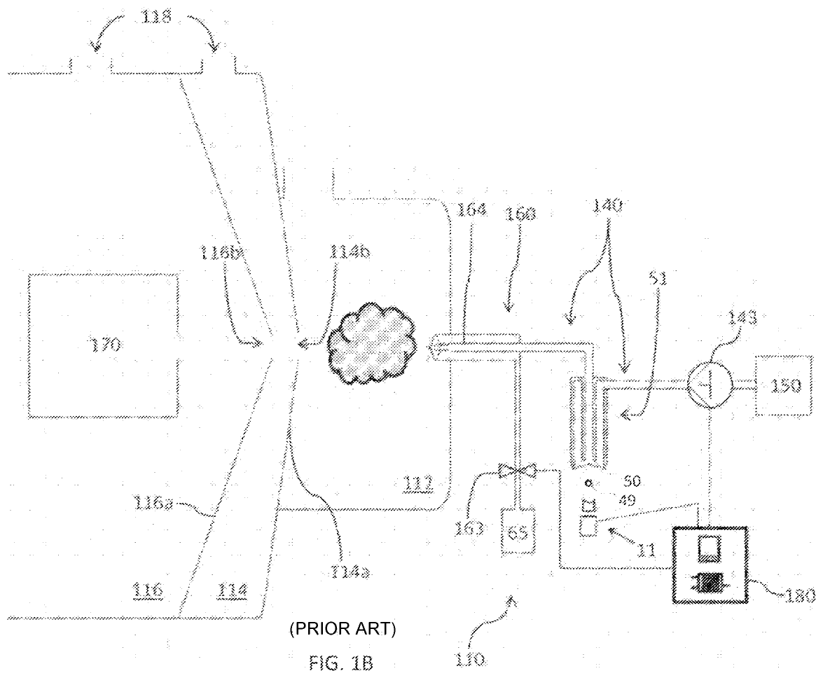

Returning to FIG. 1A, recall that an aspirating nebulization system is used so that the analyte-solvent dilution is drawn out of the sample outlet 63 by the Venturi effect caused by the flow of the nebulizing gas introduced from a nebulizing gas source 65 via gas inlet 67. The analyte-solvent dilution flow is then drawn upward through the sample transport capillary 61 by the pressure drop generated as the nebulizing gas passes over the sample outlet 63 and combines with the fluid exiting the sample transport capillary 61. If the flow of the nebulizing gas remains constant and the viscosity of the analyte-solvent dilution decreases, then the flow of the analyte-solvent dilution increases. In other words, if the flow rate of the nebulizing gas passing over the sample outlet 63 remains constant and the viscosity of methanol or acetonitrile decreases, then the flow rate of methanol or acetonitrile increases.

As described above, increasing the flow rate of the analyte-solvent dilution is advantageous for mass spectrometry or any analytical technique. Increasing the flow rate of the analyte-solvent dilution means more samples can be analyzed in the same amount of time.

A third benefit of adjusting the temperature of the solvent in an OPP device to a range of 50-60° C. is the ability to reduce the flow rate of the nebulizing gas. As just described with reference to FIG. 1A, if the flow rate of the nebulizing gas passing over the sample outlet 63 remains constant and the viscosity of analyte-solvent dilution decreases, then the flow rate of the analyte-solvent dilution increases. Conversely, if the flow rate of the analyte-solvent dilution in sample transport capillary 61 remains constant and the viscosity of analyte-solvent dilution decreases, then the flow rate of the nebulizing gas passing over the sample outlet 63 can be reduced. In other words, if the viscosity of the solvent decreases while the flow rate of the solvent is held constant, a lower flow rate of the nebulizing gas is needed to draw the solvent upward through the sample transport capillary 61.

An additional side benefit of adjusting the temperature of the solvent in an OPP device to a range of 50-60° C. is ensuring line cleanliness for applications where analyte could be “sticky.” In other words, some analytes can stick to the walls of sample transport capillary 61 if the viscosity of the solvent is high enough and the flow rate of the analyte-solvent dilution is slow enough. Increasing either or both of the viscosity of the solvent and the flow rate of the analyte-solvent dilution can help prevent this problem.

In various embodiments, the temperature of the solvent in an OPP device is increased by applying heat to the solvent through the use of a heating element. The heating element can be, but is not limited to, a resistance-type heating element, such as nichrome wire.

The heating element is located within the OPP system in order to heat the solvent so that the solvent reaches a desired temperature to reduce the viscosity below a desired viscosity level before the solvent receives the analyte sample. The heating element is also located within the OPP system in order to heat the solvent so that the solvent maintains the desired temperature to reduce the viscosity below the desired viscosity level for the entire time the analyte-solvent dilution is transported through the OPP device. In other words, the heating element is placed to heat the solvent above a certain temperature level before the analyte is introduced and have the analyte-solvent dilution maintain a temperature above that temperature level for the entire time the analyte-solvent dilution is transported through the OPP device. In this way, the viscosity of the analyte-solvent dilution is maintained below a certain viscosity level or threshold while the analyte-solvent dilution passes through the OPP device.

Returning to FIG. 1A, in various embodiments, a heating element is placed to heat the solvent in solvent inlet 57. For example, a heating element or heating sleeve can be placed before, surrounding, or in line with solvent inlet 57. In this embodiment, the solvent is heated as it enters OPP 51. The heating element heats the solvent so that it maintains a lower viscosity throughout its transit through the OPP 51.

In another embodiment, a heating element is placed to heat the solvent in solvent transport capillary 59. For example, a heating element or heating sleeve can be placed before, surrounding, or in line with transport capillary 59. In this embodiment, the solvent is heated before it receives the sample and the sample is transported through sample transport capillary 61. The heating element heats the solvent so that it maintains a lower viscosity through sample transport capillary 61.

Returning to FIG. 1B, in various embodiments, a heating element is placed to heat the solvent in one or more pumps 143. For example, a heating element or heating sleeve can be placed in or surrounding one or more pumps 143. In this embodiment, the solvent is heated before it enters OPP 51. The heating element heats the solvent so that it maintains a lower viscosity throughout its transit through the OPP 51.

### System for Transporting an Analyte to an Instrument

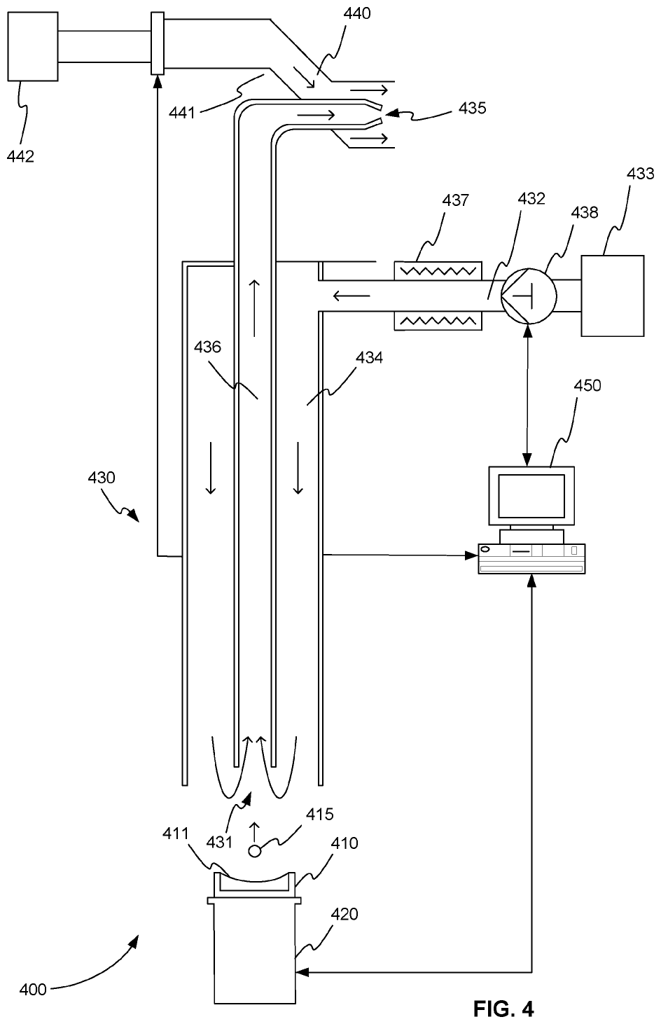

FIG. 4 is a schematic diagram 400 of a system for transporting an analyte in a fluid sample to an analytical instrument and controlling the viscosity of the fluid sample, in accordance with various embodiments. The system of FIG. 4 includes reservoir 410, ejector 420, and OPP 430.

Reservoir 410 houses a fluid sample containing an analyte. The fluid sample has fluid surface 411. Reservoir 410 is, for example, a microtiter plate well. Ejector 420 ejects droplet 415 of the fluid sample from fluid surface 411. Ejector 420 is, for example, an ADE. OPP 430 is spaced apart from fluid surface 411.

OPP 430 includes sampling tip 431 for receiving ejected droplet 415 of the fluid sample. OPP 430 includes solvent inlet 432 for receiving a solvent from solvent source or reservoir 433. OPP 430 includes solvent transport capillary 434 for transporting the solvent from solvent inlet 432 to sampling tip 431, where ejected droplet 415 combines with the solvent to form an analyte-solvent dilution. OPP 430 includes sample outlet 435 through which the analyte-solvent dilution is directed away from OPP 430 to an analytical instrument (not shown).

OPP 430 includes sample transport capillary 436 for transporting the analyte-solvent dilution from sampling tip 431 to sample outlet 435. Sample transport capillary 436 and solvent transport capillary 434 are in fluid communication at sampling tip 431. Finally, OPP 430 includes heating element 437 that heats the solvent to a temperature above a threshold temperature in order to reduce a viscosity of the solvent below a threshold viscosity. This maintains the viscosity of the solvent below a threshold viscosity as the analyte-solvent dilution is transported from sampling tip 431 to sample outlet 435.

As shown in FIG. 3, the threshold temperature can be, but is not limited to, 50-60° C. and the threshold viscosity can be, but is not limited to, 0.58 mPa·s. In various alternative embodiments, the threshold viscosity can be, but is not limited to, 0.7 mPa·s.

As shown in FIG. 4, heating element 437 is located surrounding solvent inlet 432. In various alternative embodiments, the heating element can be located before or in line with solvent inlet 432.

In various embodiments not shown, the heating element can be located before, surrounding, or in line with solvent transport capillary 434.

In various embodiments not shown, a second heating element (not shown) is located surrounding sample transport capillary 436. A second heating element is used in addition to heating element 437, for example, to maintain the viscosity of the solvent below the threshold viscosity as the analyte-solvent dilution is transported from sampling tip 431 to sample outlet 435.

In various embodiments, the system of FIG. 4 further includes solvent pump 438 operably connected to and in fluid communication with solvent inlet 432 for controlling solvent flow rate within solvent transport capillary 434.

In various embodiments not shown, the heating element is located in or surrounding solvent pump 438.

In various embodiments, solvents with higher viscosities are used. For example, the solvent can include water (H₂O), at least 50 percent water (H₂O), or isopropyl alcohol (IPA).

In various embodiments, the solvent includes methanol (MeOH), or acetonitrile (ACN).

In various embodiments, the system of FIG. 4 further includes gas inlet 440 and gas pressure regulator 441. A nebulizing gas flows from gas source 442 to sample outlet 435 so that the analyte-solvent dilution is drawn out of sample outlet 435 by the Venturi effect caused by the flow of the nebulizing gas. Gas pressure regulator 441 is operably connected to gas inlet 440 to control the nebulizing gas flow.

In various embodiments, the nebulizing gas flow is held constant as the solvent is heated in order to accommodate higher liquid flows. For example, the nebulizing gas flow is held constant by gas pressure regulator 441 as the solvent is heated by heating element 437 in order to increase the flow of the analyte-solvent dilution through sample transport capillary 436.

In various embodiments, the flow of the analyte-solvent dilution is held constant as the solvent is heated in order to reduce gas flow requirements. For example, the nebulizing gas flow is reduced by gas pressure regulator 441 as the solvent is heated by heating element 437 in order to maintain a constant flow of the analyte-solvent dilution through sample transport capillary 436.

In various embodiments, processor 450 is used to control or provide instructions to ejector 420, solvent pump 438, and gas pressure regulator 441. Processor 450 controls or provides instructions by, for example, controlling one or more voltage, current, or pressure sources (not shown). Processor 450 can be a separate device as shown in FIG. 4 or can be a processor or controller of ejector 420, solvent pump 438, gas pressure regulator 441 or the analytical instrument (not shown). Processor 450 can be, but is not limited to, a controller, a computer, a microprocessor, the computer system of FIG. 1, or any device capable of sending and receiving control signals and data.

### Method for Transporting an Analyte to an Instrument

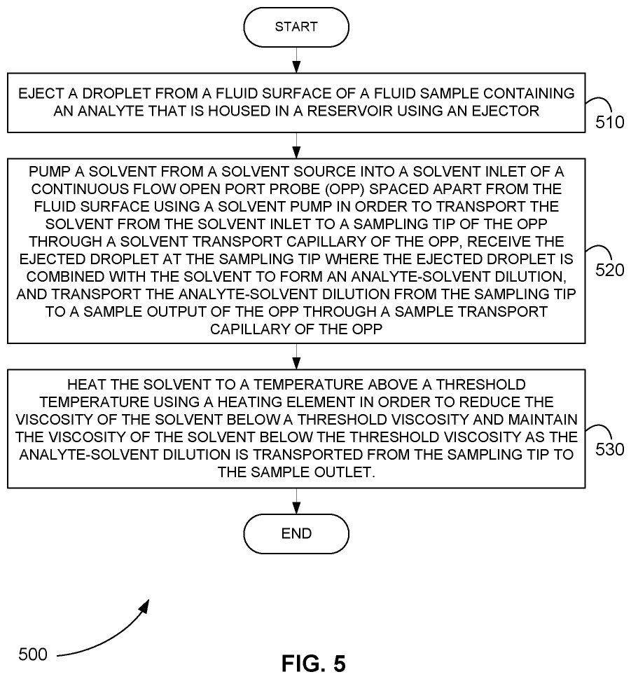

FIG. 5 is a flowchart showing a method 500 for transporting an analyte in a fluid sample to an analytical instrument and controlling the viscosity of the fluid sample, in accordance with various embodiments.

In step 510 of method 500, a droplet is ejected from a fluid surface of a fluid sample containing an analyte using an ejector. The fluid sample is housed in a reservoir.

In step 520, a solvent is pumped from a solvent source into a solvent inlet of a continuous flow OPP spaced apart from the fluid surface using a solvent pump. The solvent is pumped in order to transport the solvent from the solvent inlet to a sampling tip of the OPP through a solvent transport capillary of the OPP, receive the ejected droplet at the sampling tip where the ejected droplet is combined with the solvent to form an analyte-solvent dilution, and transport the analyte-solvent dilution from the sampling tip to a sample output of the OPP through a sample transport capillary of the OPP.

In step 530, the solvent is heated to a temperature above a threshold temperature using a heating element. The solvent is heated in order to reduce the viscosity of the solvent below a threshold viscosity and maintain the viscosity of the solvent below the threshold viscosity as the analyte-solvent dilution is transported from the sampling tip to the sample outlet.

### Computer Program Product for Transporting an Analyte to an Instrument

In various embodiments, computer program products include a tangible computer-readable storage medium whose contents include a program with instructions being executed on a processor so as to perform a method for transporting an analyte in a fluid sample to an analytical instrument and controlling the viscosity of the fluid sample. This method is performed by a system that includes one or more distinct software modules.

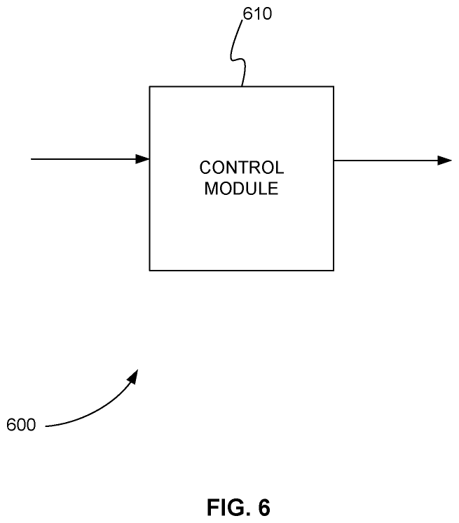

FIG. 6 is a schematic diagram of a system 600 that includes one or more distinct software modules that performs a method for transporting an analyte in a fluid sample to an analytical instrument and controlling the viscosity of the fluid sample, in accordance with various embodiments. System 600 includes control module 610.

Control module 610 instructs an ejector to eject a droplet from a fluid surface of a fluid sample containing an analyte. The fluid sample is housed in a reservoir. Control module 610 instructs a solvent pump to pump a solvent from a solvent source into a solvent inlet of a continuous flow OPP spaced apart from the fluid surface. The solvent is pumped in order to transport the solvent from the solvent inlet to a sampling tip of the OPP through a solvent transport capillary of the OPP, receive the ejected droplet at the sampling tip where the ejected droplet is combined with the solvent to form an analyte-solvent dilution, and transport the analyte-solvent dilution from the sampling tip to a sample output of the OPP through a sample transport capillary of the OPP. Finally, control module 610 instructs a heating element to heat the solvent to a temperature above a threshold temperature. The solvent is heated in order to reduce the viscosity of the solvent below a threshold viscosity and maintain the viscosity of the solvent below the threshold viscosity as the analyte-solvent dilution is transported from the sampling tip to the sample outlet.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

What is claimed is:

1. A system for transporting an analyte in a fluid sample to an analytical instrument and controlling the viscosity of the fluid sample, comprising:
(a) a reservoir housing a fluid sample containing an analyte, the fluid sample having a fluid surface;
(b) an ejector that ejects a droplet of the fluid sample from the fluid surface; and
(c) a continuous flow open port probe (OPP) spaced apart from the fluid surface, comprising (i) a sampling tip for receiving the ejected droplet of the fluid sample, (ii) a solvent inlet for receiving a solvent from a solvent source, (iii) a solvent transport capillary for transporting the solvent from the solvent inlet to the sampling tip, where the ejected droplet combines with the solvent to form an analyte-solvent dilution, (iv) a sample outlet through which the analyte-solvent dilution is directed away from the OPP to an analytical instrument, (v) a sample transport capillary for transporting the analyte-solvent dilution from the sampling tip to the sample outlet, wherein the sample transport capillary and the solvent transport capillary are in fluid communication at the sampling tip, and (vi) a heating element that heats the solvent to a temperature above a threshold temperature in order to reduce a viscosity of the solvent below a threshold viscosity and maintain the viscosity of the solvent below the threshold viscosity as the analyte-solvent dilution is transported from the sampling tip to the sample outlet.

2. The system of claim 1, wherein the heating element is located before, surrounding, or in line with the solvent inlet.

3. The system of claim 1, wherein the heating element is located before, surrounding, or in line with the solvent transport capillary.

4. The system of claim 1, wherein a second heating element is located surrounding the sample transport capillary to maintain the viscosity of the solvent below the threshold viscosity as the analyte-solvent dilution is transported from the sampling tip to the sample outlet.

5. The system of claim 1, further including a solvent pump operably connected to and in fluid communication with the solvent inlet for controlling solvent flow rate within the solvent transport capillary.

6. The system of claim 1, wherein the heating element is located in or surrounding the solvent pump.

7. The system of claim 1, wherein the solvent comprises water (H₂O).

8. The system of claim 1, wherein the solvent comprises at least 50 percent water (H₂O).

9. The system of claim 1, wherein the solvent comprises isopropyl alcohol (IPA).

10. The system of claim 1, wherein the solvent comprises methanol (MeOH).

11. The system of claim 1, wherein the solvent comprises acetonitrile (ACN)

12. The system of claim 1, further including a gas inlet through which a nebulizing gas flows from a gas source to the sample outlet so that the analyte-solvent dilution is drawn out of the sample outlet by the Venturi effect caused by the flow of the nebulizing gas and a gas pressure regulator operably connected to the gas inlet to control the nebulizing gas flow, wherein the nebulizing gas flow is held constant by the gas pressure regulator as the solvent is heated by the heating element in order to increase the flow of the analyte-solvent dilution through the sample transport capillary.

13. The system of claim 1, wherein the nebulizing gas flow is reduced by the gas pressure regulator as the solvent is heated by the heating element in order to maintain a constant flow of the analyte-solvent dilution through the sample transport capillary.

14. A method for transporting an analyte in a fluid sample to an analytical instrument and controlling the viscosity of the fluid sample, comprising:
ejecting a droplet from a fluid surface of a fluid sample containing an analyte that is housed in a reservoir using an ejector;
pumping a solvent from a solvent source into a solvent inlet of a continuous flow open port probe (OPP) spaced apart from the fluid surface using a solvent pump in order to transport the solvent from the solvent inlet to a sampling tip of the OPP through a solvent transport capillary of the OPP, receive the ejected droplet at the sampling tip where the ejected droplet is combined with the solvent to form an analyte-solvent dilution, and transport the analyte-solvent dilution from the sampling tip to a sample output of the OPP through a sample transport capillary of the OPP; and
heating the solvent to a temperature above a threshold temperature using a heating element in order to reduce a viscosity of the solvent below a threshold viscosity and maintain the viscosity of the solvent below the threshold viscosity as the analyte-solvent dilution is transported from the sampling tip to the sample outlet.

15. A computer program product, comprising a non-transitory and tangible computer-readable storage medium whose contents include a program with instructions being executed on a processor so as to perform a method for transporting an analyte in a fluid sample to an analytical instrument and controlling the viscosity of the fluid sample, the method comprising:
providing a system, wherein the system comprises one or more distinct software modules, and wherein the distinct software modules comprise a control module;
instructing an ejector to eject a droplet from a fluid surface of a fluid sample containing an analyte that is housed in a reservoir;
instructing a solvent pump to pump a solvent from a solvent source into a solvent inlet of a continuous flow open port probe (OPP) spaced apart from the fluid surface in order to transport the solvent from the solvent inlet to a sampling tip of the OPP through a solvent transport capillary of the OPP, receive the ejected droplet at the sampling tip where the ejected droplet is combined with the solvent to form an analyte-solvent dilution, and transport the analyte-solvent dilution from the sampling tip to a sample output of the OPP through a sample transport capillary of the OPP; and
instructing a heating element to heat the solvent to a temperature above a threshold temperature in order to reduce a viscosity of the solvent below a threshold viscosity and maintain the viscosity of the solvent below the threshold viscosity as the analyte-solvent dilution is transported from the sampling tip to the sample outlet.
